(19) United States
(12) Patent Application Publication
(10) Pub. No.: US 2010/0232140 A1
(43) Pub. Date: Sep. 16, 2010

(54) LAMP HOLDER, BACKLIGHT UNIT AND DISPLAY DEVICE

(75) Inventor: Mitsuhiro Takeba, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/680,218

(22) PCT Filed: Jun. 18, 2008
(86) PCT No.: PCT/JP2008/061145

§ 371 Date: Mar. 26, 2010

(30) Foreign Application Priority Data
Sep. 28, 2007 (JP) 2007-254320

(51) Int. Cl. F21V 19/00; G09F 13/04

(52) U.S. Cl. 362/97.1; 362/427

(57) ABSTRACT

A lamp holder that is capable of reducing the number of lamp holder types required for setting a variety of the intervals between the light source lamps such that the interval is shorter in the center portion and wider in the respective end portions for example. The lamp holder 20 has a plurality of lamp clips 21, 21 that hold two CCFLs at a predetermined interval and are rotatably supported on a base of the lamp holder 20.

### BACKGROUND OF THE INVENTION

1. Field of the Invention

The present invention relates to a backlight unit disposed at a back surface side of a display panel for irradiating light to the display panel, and more particularly, to a lamp holder which supports plural light source lamps arranged in rows inside the backlight unit on a lamp housing surface.

2. Description of the Related Art

Recently, a liquid crystal display device has been widely used as a flat type display device. In particular, the liquid crystal display device employed for a TV set is provided with a liquid crystal display panel on which images are displayed, and a backlight unit disposed at a back surface side of the liquid crystal display panel. The backlight unit includes the light source lamp, for example, plural cold cathode fluorescent lamps (hereinafter referred to as CCFL) for adjusting the property of the light emitted therefrom so as to be irradiated to the back surface side of the liquid crystal display panel. The irradiated light transmits the liquid crystal display panel to visualize the image to be displayed on the front of the liquid crystal display panel.

FIG. 11 schematically illustrates a structure of a conventional liquid crystal display device. A liquid crystal display device 50 illustrated in the drawing includes a liquid crystal display panel 51 for displaying images, and a backlight unit 52 disposed at the back surface side of the liquid crystal display panel 51.

Light emitted from the plural CCFLs 54 arranged in rows inside a low-height box-shaped backlight chassis 53 transmits an optical sheet 56 and the liquid crystal display panel 51 together with the light reflecting from a reflection sheet 55 to be viewed by a viewer. The optical sheet 56 adjusts the property of the incident light from the CCFL 54 to the liquid crystal display panel 51.

FIG. 12 is a front view of the backlight unit 52. As disclosed in Japanese Laid-open Patent Publication No. H6-75216, the interval between adjacent CCFLs 54 is set to be shorter in the center portion and wider in the respective end portions such that the luminance at the center of the screen of the liquid crystal display panel 51 is the highest and the luminance is gradually lowered toward the respective end portions. The aforementioned method is employed for reducing the number of the CCFLs 54 to be smaller than that of the conventional structure while preventing the viewer from recognizing the uneven luminance.

In this case, the illustrated CCFLs 54 are supported on a lamp housing surface of the backlight chassis 53 with lamp holders 57 and 58 as disclosed in Japanese Laid-open Patent Publication No. 2001-210126. The intermediate portion of the CCFL 54 is supported with the lamp holder 57 or 58 as the use of electrode holders 59, 59 at both ends may fail to provide positioning accuracy sufficient to support the long CCFL 54.

In the aforementioned case, the interval between the adjacent CCFLs 54 is shorter in the center portion and wider in the respective end portions using two different types of lamp holders 57 and 58 as illustrated in FIGS. 13A and 13B. Each of the lamp holders 57 and 58 includes two lamp clips 62, 62 at both ends of rectangular bases 60 and 61. The lamp clip 62 has a circular shape with an open upper portion with which the CCFL 54 is clipped.

A rod-shaped sheet support pin 63 protrudes at a position between the clips 62, 62, which has a length set to separate the optical sheet 56 from the reflection sheet 55 by a predetermined interval. This may prevent the optical sheet 56 at the upper side from being deformed downward, thus preventing unevenness of luminance. Engaging portions 64, 64 below the lamp clips 62, 62 are engaged with engaging holes 65, 65 formed in the reflection sheet 55 and the backlight chassis 53 for fixation.

Two types of lamp holders 57, 58 each having different interval between the lamp clips 62, 62 as illustrated in FIGS. 13A and 13B are required for setting the interval between the adjacent CCFLs 54 so as to be shorter in the center portion and wider in the respective end portions. Consequently, the number of components for forming the backlight unit 52 is increased, resulting in difficulty in manufacturing cost reduction.

The present invention provides a lamp holder, a backlight unit, and a display device, which are capable of reducing the number of lamp holder types required for setting a variety of the intervals between the light source lamps such that the interval is shorter in the center portion and wider in the respective end portions for example.

### SUMMARY OF THE INVENTION

In order to overcome the problems described above, a preferred embodiment of the present invention provide a lamp holder having a plurality of lamp clips that hold a plurality of light source lamps at predetermined intervals and are rotatably supported on a base of the lamp holder.

It is preferable that the lamp clips are two in number. It is also preferable that the lamp clips are integrated with engaging portions that are to be inserted into engaging holes formed in a flat lamp housing surface and the engaging portions are rotated in accordance with rotation of the lamp clips. In addition, it is preferable that the engaging portions of the lamp clips are inserted into the engaging holes formed in the lamp housing surface, and rotated together with the lamp clips so as not to be removed from the engaging holes formed in the lamp housing surface.

Another preferred embodiment of the present invention provides a backlight unit that is disposed on a back surface of a display panel having an image display region, and irradiates light to the display panel, wherein a plurality of light source lamps are provided in rows on a flat lamp housing surface, each two or more of the plurality of light source lamps are held with a lamp holder, a plurality of lamp clips that hold the two or more of the plurality of light source lamps at predetermined intervals are rotatably supported on a base of the lamp holder, and the lamp holder is obliquely directed in accordance with the intervals between the light source lamps to be held.

It is preferable that the lamp clips of the lamp holder are two in number. It is also preferable that the lamp clips are integrated with engaging portions that are to be inserted into engaging holes formed in a flat lamp housing surface and the engaging portions are rotated in accordance with rotation of the lamp clips. In addition, it is preferable that the engaging portions of the lamp clips are inserted into the engaging holes formed in the lamp housing surface, and rotated together with the lamp clips so as not to be removed from the engaging holes formed in the lamp housing surface.

Yet another preferred embodiment of the present invention provides a display device having a backlight unit that is disposed at a back surface side of a display panel having an image display region, and irradiates light to the display panel, wherein the backlight unit is provided with a plurality of light source lamps in rows on a flat lamp housing surface, each two or more of the plurality of light source lamps are held with a lamp holder, a plurality of lamp clips that hold the two or more of the plurality of light source lamps at predetermined intervals are rotatably supported on a base of the lamp holder, and the lamp holder is obliquely directed in accordance with the intervals between the light source lamps to be held.

It is preferable that the lamp clips of the lamp holder are two in number. It is also preferable that the lamp clips are integrated with engaging portions that are to be inserted into engaging holes formed in a flat lamp housing surface and the engaging portions are rotated in accordance with rotation of the lamp clips. In addition, it is preferable that the engaging portions of the lamp clips are inserted into the engaging holes formed in the lamp housing surface, and rotated together with the lamp clips so as not to be removed from the engaging holes formed in the lamp housing surface.

The present invention provides a lamp holder which has plural lamp clips that hold plural light source lamps at predetermined intervals and are rotatably supported on a base of the lamp holder. The lamp holder is obliquely directed in accordance with the interval between the light source lamps held on the lamp housing surface so as to accommodate plural intervals between the light source lamps. This makes it possible to reduce the number of lamp holder types required for setting a variety of intervals between the light source lamps such that the interval is shorter in the center portion and wider in the respective end portions. It is not necessary to prepare the plural types of lamp holders as in the general case, thus reducing manufacturing cost compared with the related art structure.

The use of the lamp holder having two lamp clips may accommodate arrangement of the general number of the light source lamps. The lamp clip is integrated with an engaging portion to be inserted into an engaging hole formed in a flat lamp housing surface. The engaging portion is rotated in accordance with rotation of the lamp clip. The engaging portion of the lamp clip is inserted into the engaging hole formed in the lamp housing surface, and rotated together with the lamp clip so as not to be removed from the engaging hole formed in the lamp housing surface. This prevents detachment of the lamp holder from the lamp housing surface. The lamp clips may be rotated to allow the engaging portions of the lamp holder to be removed from the engaging holes formed in the lamp housing surface. This may improve the workability for removing the lamp holder during replacement of the reflection sheet.

### BRIEF DESCRIPTION OF THE DRAWINGS

FIG. 1 is a partial exploded perspective view of a liquid crystal display device according to a first preferred embodiment of the present invention.

FIG. 2 is a front view of a backlight unit for the liquid crystal display device shown in FIG. 1.

FIG. 3A is an exploded perspective view of a lamp holder according to the first preferred embodiment of the present invention, and FIG. 3B is a perspective external view of the assembled lamp holder.

FIG. 4A is a perspective external view showing a state before attachment of the lamp holder onto a lamp housing surface, in which two CCFLs are held at a lamp holding interval of P1. FIG. 4B is a perspective external view showing a state before attachment of the lamp holder onto the lamp housing surface, in which two CCFLs are held at a lamp holding interval of P2.

FIG. 5 is a partial exploded perspective view of a liquid crystal display device according to a second preferred embodiment of the present invention.

FIG. 6 is a front view of a backlight unit for the liquid crystal display device shown in FIG. 5.

FIG. 7A is an exploded perspective view of a lamp holder according to the second preferred embodiment of the present invention, and FIG. 7B is a perspective external view of the assembled lamp holder.

FIG. 8A is a perspective external view showing a state before attachment of the lamp holder onto a lamp housing surface, in which two CCFLs are held at a lamp holding interval of P1. FIG. 8B is a perspective external view showing a state after attachment of the lamp holder onto the lamp housing surface.

FIG. 9A is a perspective external view showing a state before attachment of the lamp holder onto a lamp housing surface, in which two CCFLs are held at a lamp holding interval of P2. FIG. 9B is a perspective external view showing a state after attachment of the lamp holder onto the lamp housing surface.

FIGS. 10A and 10B are views showing the lamp holders according to the preferred embodiments of the present invention in use. FIG. 10A is a front view of the backlight unit having only the lamp holding interval P1, while FIG. 10B is a front view of the backlight unit having only the lamp holding interval P2.

FIG. 11 is an exploded view schematically showing a structure of a conventional liquid crystal display device.

FIG. 12 is a front view of a backlight unit for the liquid crystal display device shown in FIG. 11.

FIGS. 13A and 13B are views showing lamp holders for the backlight unit shown in FIG. 11. FIG. 13A is a perspective external view of the lamp holder that holds two CCFLs at a predetermined interval. FIG. 13B is an external perspective view of the lamp holder that hold two CCFLs at an interval that is longer than that of the CCFLs shown in FIG. 13A.

### DETAILED DESCRIPTION OF THE PREFERRED EMBODIMENTS

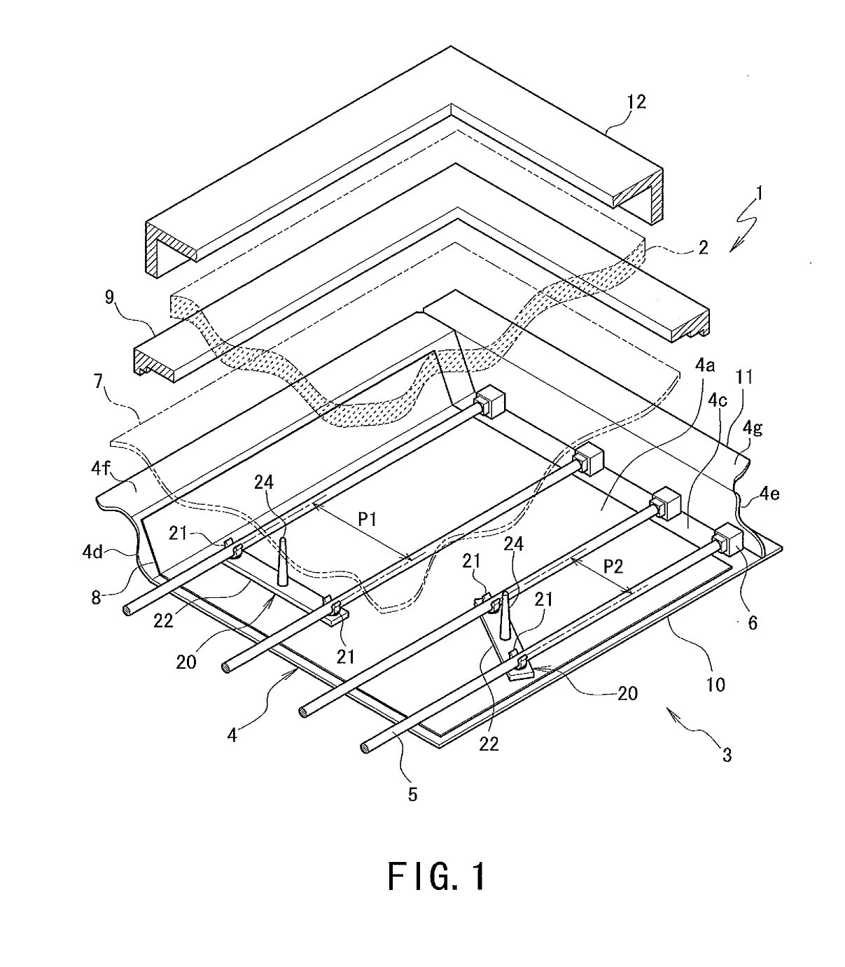

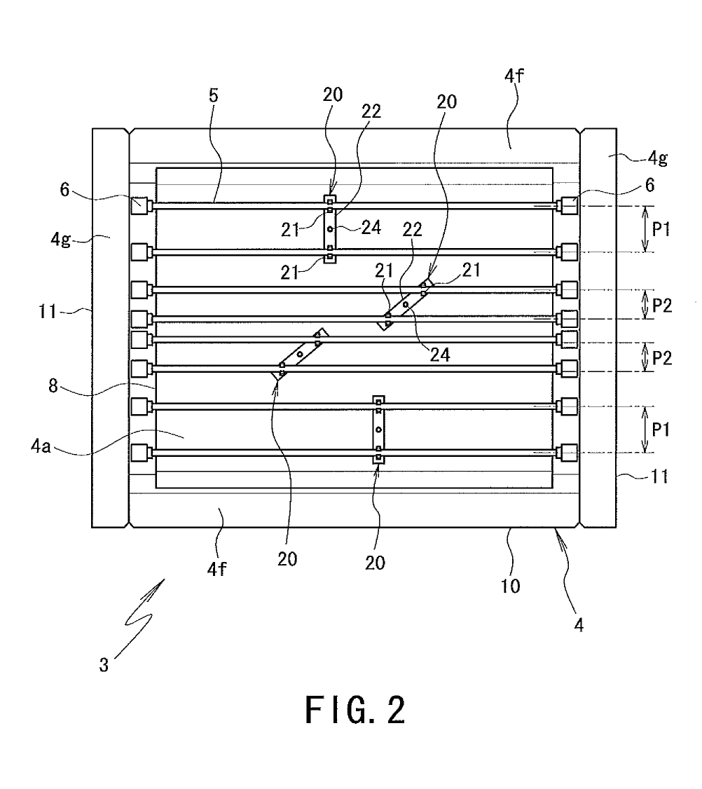

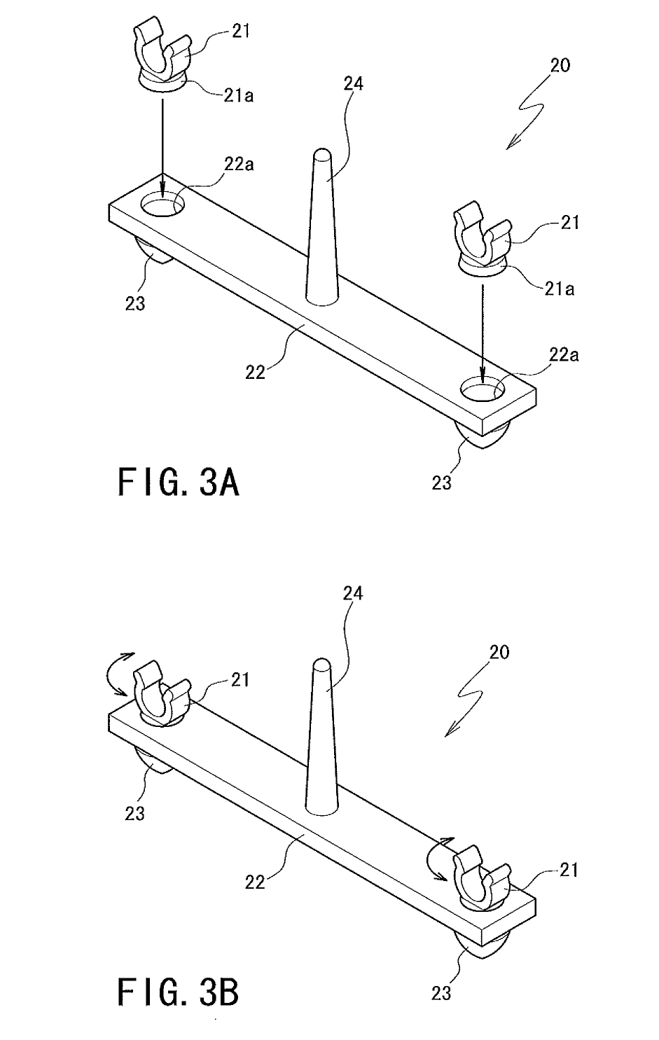

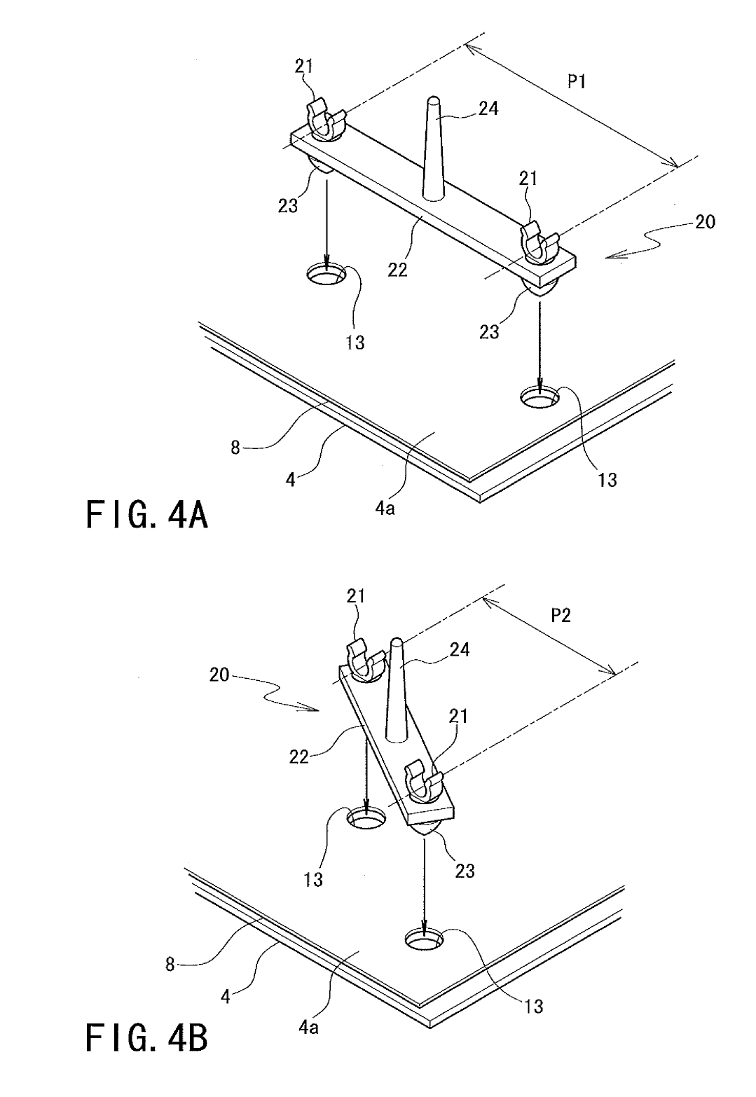

A lamp holder, a backlight unit, and a display device according to a first preferred embodiment of the present invention will be described referring to FIGS. 1 to 4B. FIG. 1 is a partial exploded perspective view of a liquid crystal display device according to the first preferred embodiment of the present invention. FIG. 2 is a front view of the backlight unit. FIGS. 3A and 3B are perspective views of an outer appearance of the lamp holder. FIGS. 4A and 4B are perspective views of an outer appearance of the lamp holder before it is attached to a lamp housing surface. The exploded perspective view in FIG. 1 represents the liquid crystal display panel and the backlight unit corresponding to the region from the center of the upper half to the right side of the structure as illustrated in FIG. 2.

Referring to FIG. 1, a liquid crystal display device 1 includes a backlight unit 3 disposed at a back surface side of a liquid crystal display panel 2. The liquid crystal display panel 2 is formed by arranging a pair of a thin film transistor (TFT) substrate and a color filter (CF) substrate in parallel at a predetermined interval while having a liquid crystal therebetween. The light from the backlight unit 3 is irradiated to the back surface side of the liquid crystal display panel 2. The irradiated light transmits the liquid crystal display panel 2 to visualize the image to be displayed on the front thereof.

The backlight unit 3 for irradiating the light to the liquid crystal display panel 2 includes a low-height box-shaped backlight chassis 4. Eight cold cathode fluorescent lamps (CCFL) 5 of the straight type are arranged as light source lamps on a lamp housing surface 4a in the chassis 4. In this case, the interval between the adjacent CCFLs 5, 5 is shorter in the center portion and wider in the upper and lower end portions as illustrated in FIG. 2. Each of the CCFLs 5 has both end portions attached to base holders 6, 6, and is fixed to the backlight chassis 4.

An optical sheet 7 disposed above the CCFLs 5 is formed by laminating plate-shaped or sheet-shaped optical members such as a diffusion plate, a diffusion sheet, a lens sheet, and a polarized reflection film for adjusting property of the incident light to the liquid crystal display panel 2 from the CCFLs 5, and the light reflecting from a reflection sheet 8. The optical sheet 7 is fixed to support surfaces 4f and 4g of the backlight chassis 4 by a frame 9, which is shaped like a picture frame.

The backlight chassis 4 includes a member 10 having a bottom plate 4c constituting the lamp housing surface 4a and a long side wall 4d formed through sheet-metal processing of a metal plate, and members 11, 11 each having a short side wall 4e formed through resin molding. The backlight chassis 4 includes the support surfaces 4f, 4g each extending outward from the upper ends of the side walls 4d, 4e, respectively. The optical sheet 7 is mounted on the support surfaces 4f, 4g and fixed by the frame 9. The liquid crystal display panel 2 is mounted on the upper surface of the frame 9 and fixed with a bezel 12, which is shaped like a picture frame. The white reflection sheet 8 is disposed below the CCFLs 5 for reflecting the light irradiated from the CCFLs 5 toward the liquid crystal display panel 2.

An inverter circuit board (not shown) for generating a high pulse voltage for driving the CCFLs 5, and a control circuit board (not shown) for controlling the liquid crystal display panel 2 are disposed on a back surface of the backlight chassis 4.

The CCFL 5 is fixed to the lamp housing surface 4a using not only the aforementioned electrode holders 6, 6 but also using a lamp holder 20 that holds the intermediate portion of the CCFL 5 as illustrated in the drawing. Lamp clips 21, 21 disposed at both ends of the lamp holder 20 are rotatably supported on a plate-shaped base 22. In this case, the lamp holder 20 may be longitudinally directed or obliquely directed at an angle of 45° with respect to the longitudinal position on the lamp housing surface 4a. As shown in FIG. 2, the first and the second CCFLs 5, 5 and the seventh and the eighth CCFLs 5, 5 from the upper side are held by the longitudinally directed lamp holders 20, 20, and the third and the fourth CCFLs 5, 5 and the fifth and the sixth CCFLs 5, 5 from the upper side are held by the lamp holders 20, 20 obliquely directed rightward at 45°.

FIG. 3A is an exploded perspective view of the lamp holder 20. Referring to the drawing, attachment portions 21a, 21a of the lamp clips 21, 21 each formed of a white or transparent synthetic resin are engaged with recess portions 22a, 22a formed in both ends of the rectangular plate-shaped base 22 which is formed of a white or transparent synthetic resin. FIG. 3B illustrates a state where the lamp clips 21, 21 are attached to the base 22 of the lamp holder 20. In this case, the attachment portion 21a of the lamp clip 21 has an inverse tapered shape having a cylindrical outer circumferential surface widened downward. Once the attachment portion 21a is engaged with the recess portion 22a of the base 22, it is hardly removed.

The lamp clip 21 has a segmental circular shape with an open upper portion so as to hold the single CCFL 5. When the lamp clip 21 is engaged with the recess portion 22a of the base 22, it may be rotatably supported as shown in FIG. 3B. Since the lamp holder 20 is provided with the lamp clips 21, 21 which are rotatably supported at both ends on the upper surface of the base 22, the lamp clips 21, 21 are capable of setting a variety of intervals between the CCFLs 5, 5 by rotating the lamp clips 21, 21 at the same angle in the same direction with respect to the base 22. Engaging portions 23, 23 are formed to protrude downward at both ends on the lower surface of the base 22.

A rod-shaped sheet support pin 24 is disposed at the center of the upper surface of the base 22, which extends by a predetermined length. This prevents the optical sheet 7 disposed above the sheet support pin 24 from being deformed downward, thus preventing unevenness of luminance.

FIG. 4A illustrates a state before attachment of the lamp holder 20 onto the lamp housing surface 4a. Referring to the drawing, the lamp holder 20 is disposed to have the base 22 longitudinally directed on the lamp housing surface 4a, and the lamp clips 21, 21 are directed orthogonal to the longitudinal direction of the base 22. The reflection sheet 8 constituting the lamp housing surface 4a and the backlight chassis 4 have longitudinally arranged engaging holes 13, 13. The engaging portions 23, 23 of the lamp holder 20 are engaged with the engaging holes 13, 13 to fix the lamp holder 20 onto the lamp housing surface 4a. This makes it possible to hold the two adjacent CCFLs 5, 5 at a predetermined lamp holding interval P1 as illustrated in FIGS. 1 and 2.

FIG. 4B illustrates a state before attachment of the lamp holder 20 onto the lamp housing surface 4a, which is different from the one shown in FIG. 4A. Referring to the drawing, the lamp holder 20 is disposed to have the base 22 obliquely directed on the lamp housing surface 4a, and each of the lamp clips 21, 21 is obliquely directed rather than orthogonally with respect to the longitudinal direction of the base 22. The reflection sheet 8 constituting the lamp housing surface 4a and the backlight chassis 4 have obliquely arranged engaging holes 13, 13. The engaging portions 23, 23 of the lamp holder 20 are engaged with the engaging holes 13, 13 to fix the lamp holder 20 onto the lamp housing surface 4a. As illustrated in FIGS. 1 and 2, two CCFLs 5, 5 may be clipped at a lamp holding interval P2 that is shorter than the lamp holding interval P1.

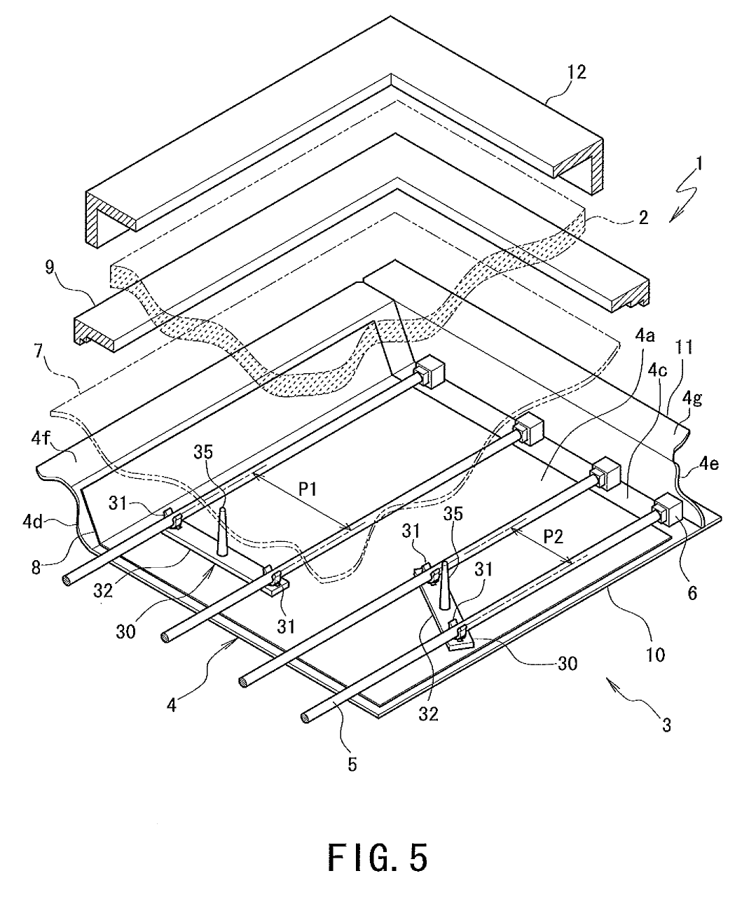

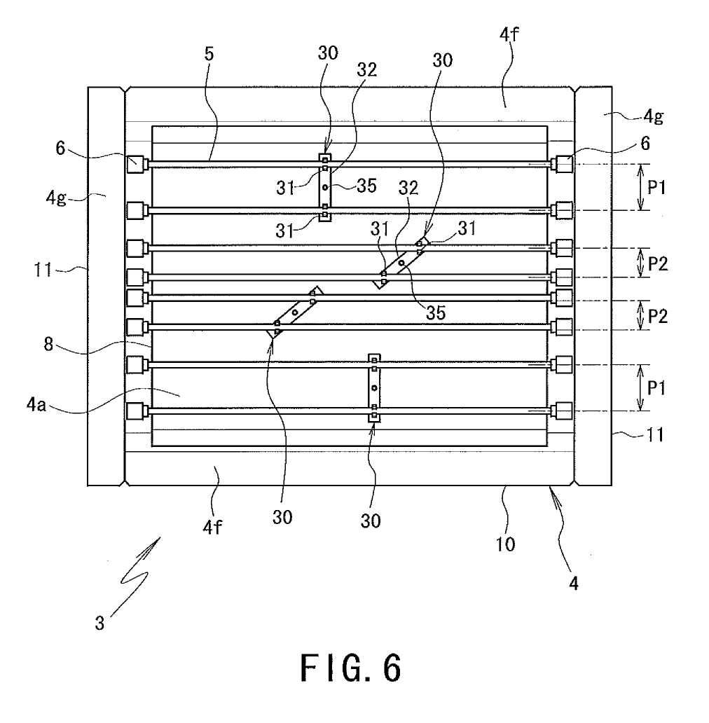

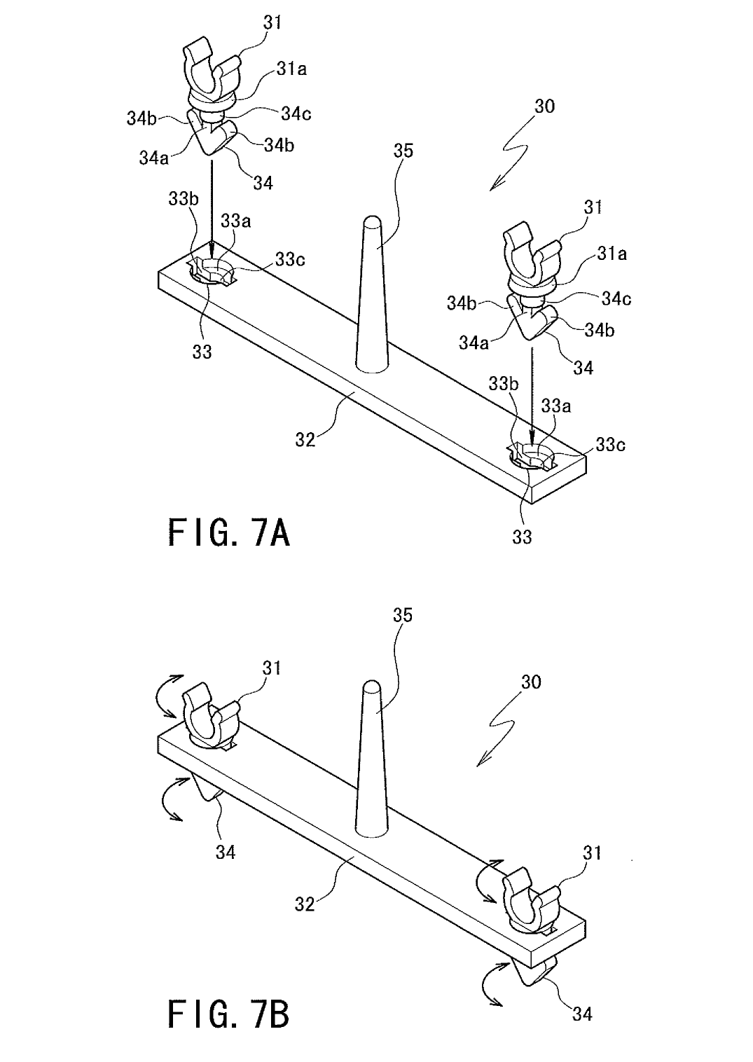

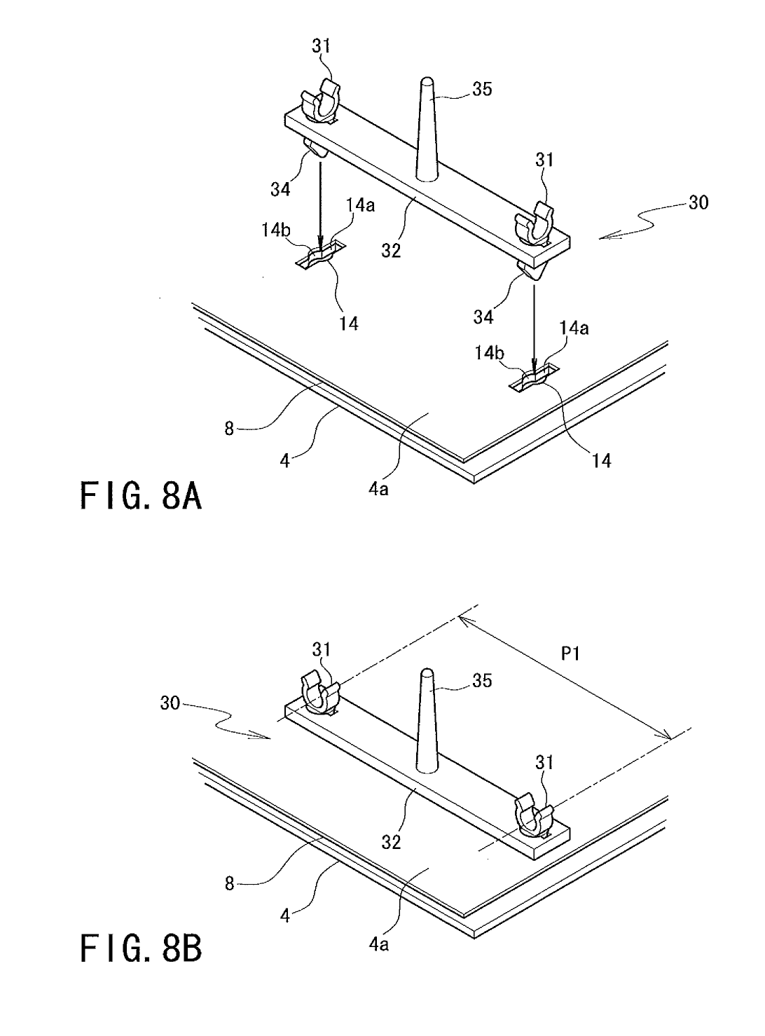

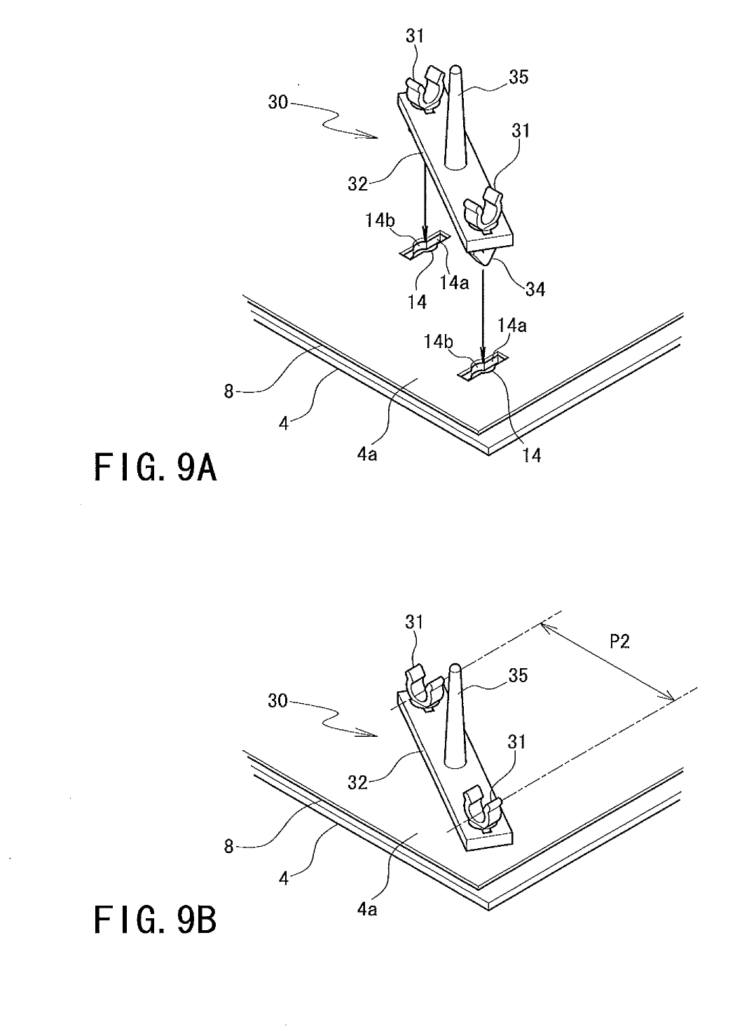

A lamp holder, the backlight unit and the display device according to a second preferred embodiment of the present invention will be described referring to FIGS. 5 to 9B. FIG. 5 is a partial exploded perspective view of a liquid crystal display device according to the second preferred embodiment. FIG. 6 is a front view of the backlight unit. FIGS. 7A and 7B are perspective views of the outer appearance of the lamp holder. FIGS. 8A to 9B are perspective views of the outer appearance of the lamp holder illustrating before and after its attachment to the lamp housing surface, respectively. The same structures as those described in the first preferred embodiment will be designated with the same signs, and explanations thereof, thus will be omitted. The different structure will only be described hereinafter.

The lamp holder 20 according to the first preferred embodiment is configured such that the engaging portion 23 for fixation to the lamp housing surface 4a is integrated with the base 22. A lamp holder 30 according to the second preferred embodiment as illustrated in FIG. 7A is configured such that an engaging portion 34 for fixation to the lamp housing surface 4a is integrated with a lamp clip 31.

The lamp clips 31, 31 at both ends of the lamp holder 30 as illustrated in FIG. 5 are rotatably supported on a plate-shaped base 32. In this case, the lamp holder 30 is longitudinally directed or obliquely directed rightward at an angle of 45° with respect to the longitudinal position on the lamp housing surface 4a. Referring to FIG. 6, the first and the second CCFLs 5, 5 and the seventh and the eighth CCFLs 5, 5 from the upper side are held by the longitudinally directed lamp holders 30, 30, and the third and the fourth CCFLs 5,5 and the fifth and the sixth CCFLs 5, 5 from the upper side are held by the lamp holders 30, 30 obliquely directed rightward at 45°.

FIG. 7A is an exploded perspective view of the lamp holder 30. An attachment portion 31a and an engaging portion 34 are provided below the lamp clip 31 as shown in the drawing. The attachment portion 31a has an inverse tapered shape having a cylindrical outer circumferential surface widened downward. Once the attachment portion 31a is engaged with the recess portion 33a of the attachment hole 33 formed in the base 32, it is hardly removed. The engaging portion 34 is formed of a shaft portion 34a extending downward from the lower surface of the attachment portion 31a, and a pair of elastic engaging portions 34b, 34b each extending from the tip end of the shaft portion 34a obliquely upward. Each cross section of the shaft portion 34a and the elastic engaging portions 34b, 34b has a square shape. A cylindrical portion 34c at a base end of the shaft portion 34a has a circular cross section.

When the engaging portion 34 integrated with the lamp clip 31 is inserted into an attachment hole 33 formed in the base 32 of the lamp holder 30, the engaging portion 34 protrudes from the lower surface of the base 32 of the engaging portion 34 as illustrated in FIG. 7B. The attachment hole 33 includes a recess portion 33a with which the attachment portion 31a of the lamp clip 31 is engaged, and a rectangular long hole 33b which penetrates the base 32 from the recess portion 33a. The engaging portion 34 is inserted into the long hole 33b. A circular insertion hole 33c having a diameter larger than the short side of the long hole 33b is formed at the center of the long hole 33b, into which the cylindrical portion 34c of the engaging portion 34 is inserted.

When the lamp clip 31 is engaged with the attachment hole 33 formed in the base 32, the lamp clip 31 is rotatably supported together with the engaging portion 34 as illustrated in FIG. 7B. The lamp holder 30 includes the lamp clips 31, 31 rotatably supported on the upper surface of the base 32 at both end portions. The lamp clips 31, 31 that hold the CCFLs 5, 5 may be rotated in the same direction at the same angle with respect to the base 32 to arbitrarily seta variety of intervals between the CCFLs 5, 5.

A rod-shaped sheet support pin 35 is disposed on the upper surface of the base 32 at its center, which prevents the optical sheet 7 disposed above the sheet support pin 35 from being deformed downward, thus preventing unevenness of luminance.

FIGS. 8A and 8B illustrate states before and after attachment of the lamp holder 30 onto the lamp housing surface 4a, respectively. Referring to FIG. 8A, the lamp holder 30 is disposed on the lamp housing surface 4a such that the base 32 is longitudinally directed. Engaging holes 14, 14 formed in the reflection sheet 8 constituting the lamp housing surface 4a and the backlight chassis 4 are longitudinally arranged. In this case, the engaging hole 14 includes a long hole 14a through which the shaft portion 34a and the elastic engaging portions 34b, 34b of the engaging portion 34 of the lamp holder 30 are inserted, and an insertion hole 14b through which the cylindrical portion 34c of the engaging portion 34 is inserted.

The engaging portions 34, 34 are inserted into the engaging holes 14, 14 such that each longitudinal direction of the engaging portions 34, 34 of the lamp holder 30 is aligned with that of the long holes 14a, 14a of the engaging holes 14, 14 formed in the lamp housing surface 4a. The engaging portions 34, 34 then protrude downward from the lower surfaces of the engaging holes 14, 14.

Thereafter, the lamp clips 31, 31 are rotated to be orthogonally directed with respect to the longitudinal direction of the base 32 as illustrated in FIG. 8B, and the engaging portions 34, 34 are rotated correspondingly. Longitudinal direction of the engaging portions 34, 34 of the lamp holder 30 orthogonally intersects longitudinal direction of the long holes 14a, 14a of the engaging holes 14, 14 formed in the lamp housing surface 4a. As a result, the lamp holder 30 is engaged with the engaging holes 14, 14 formed in the lamp housing surface 4a so as not to be removed therefrom. Referring to the drawing, two CCFLs 5, 5 are brought into the clipped state at a predetermined lamp holding interval P1. As FIGS. 5 and 6 illustrate, the CCFLs 5, 5 may be clipped at the predetermined lamp holding interval P1.

FIGS. 9A and 9B illustrate states before and after attachment of the lamp holder 30 to the lamp housing surface 4a, which are different from those shown in FIGS. 8A and 8B. Referring to FIG. 9A, the lamp holder 30 is disposed to have the base 32 obliquely directed on the lamp housing surface 4a. The engaging holes 14, 14 formed in the reflection sheet 8 constituting the lamp housing surface 4a and the backlight chassis 4 are obliquely arranged as well.

The engaging portions 34, 34 of the lamp holder 30 are inserted into the engaging holes 14, 14 such that longitudinal direction of the engaging portions 34, 34 is aligned with that of the long holes 14a, 14a of the engaging holes 14, 14. The engaging portions 34, 34 protrude downward from the lower surfaces of the engaging holes 14, 14.

Thereafter, the lamp clips 31, 31 are rotated to be obliquely directed with respect to the longitudinal direction of the base 32 as illustrated in FIG. 9B, and the engaging portions 34, 34 are rotated correspondingly. Since the longitudinal direction of the engaging portions 34, 34 of the lamp holder 30 orthogonally intersects the longitudinal direction of the long holes 14a, 14a of the engaging holes 14, 14 formed in the lamp housing surface 4a, the lamp holder 30 is engaged with the engaging holes 14, 14 formed in the lamp housing surface 4a so as not to be removed therefrom. Referring to the drawing, two CCFLs 5, 5 are brought into the clipped state at a predetermined lamp holding interval P2 which is shorter than the lamp holding interval P1. As FIGS. 5 and 6 illustrate, the CCFLs 5, 5 may be clipped at the predetermined lamp holding interval P2.

The lamp holder 30 may be easily removed from the lamp housing surface 4a by performing the inverse procedure for attachment of the lamp holder 30 to the lamp housing surface 4a as described above. The advantage of easy removal of the lamp holder 30 from the lamp housing surface 4a will be described hereinafter.

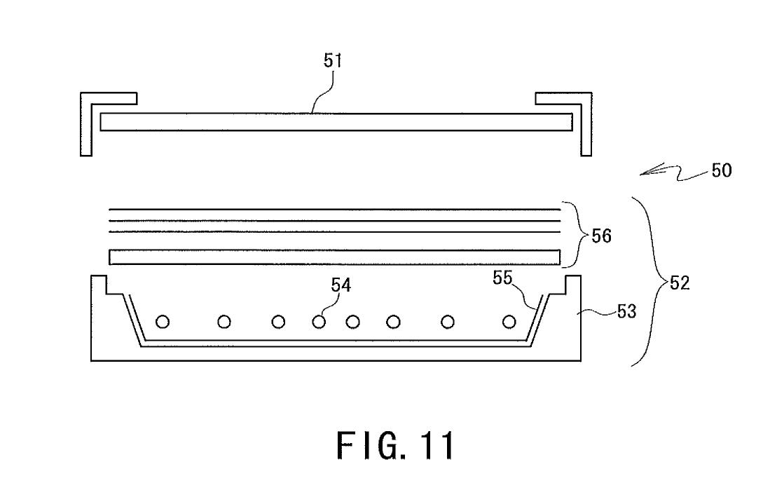

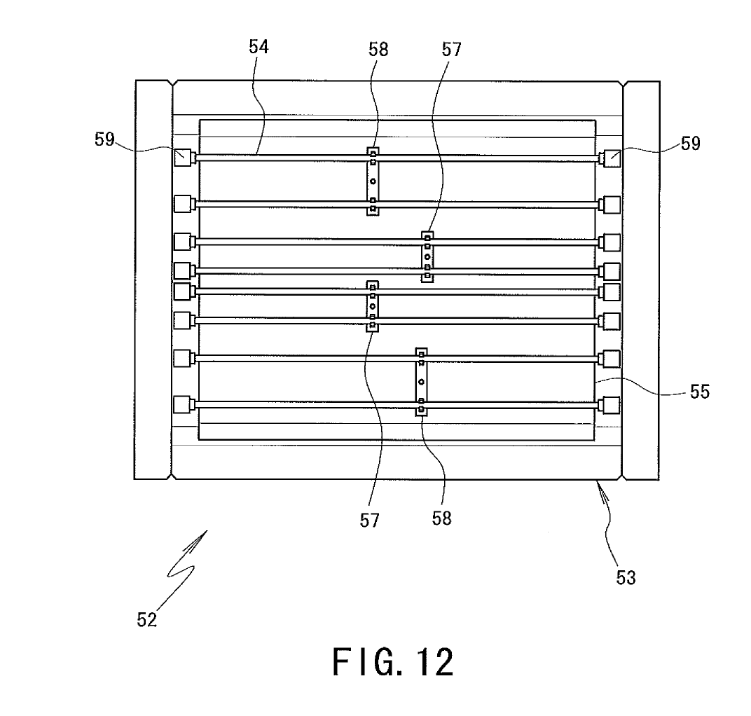

There may be often the case where the lamp holders 57, 58 as related art illustrated in FIGS. 11 to 13 are removed for replacement of the reflection sheet 55 or recycling of the liquid crystal display device 50. In the case where the reflection sheet 55 is flawed or broken, it should be replaced with a new one by removing the lamp holders 57, 58. The used liquid crystal display device 50 is required to have the respective components sorted out in accordance with the material type (metal, synthetic resin and the like) for disposal and recycling. The lamp holders 57, 58 formed of a resin are removed from the metal backlight chassis 53.

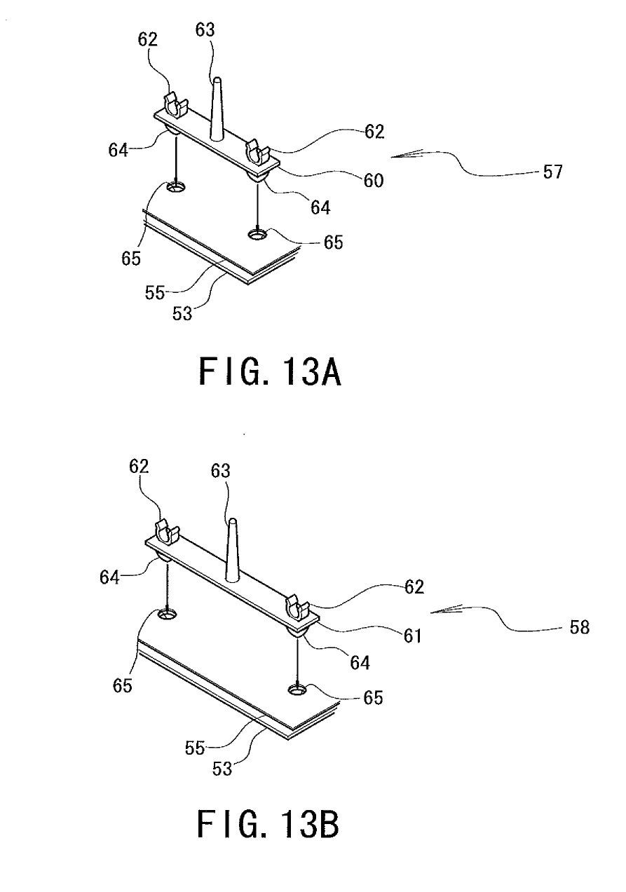

In the aforementioned case, the engaging portion 64 is removed from the engaging hole 65 by elastically pressing the outer circumference of the tip of the engaging portion 64 of each of the lamp holders 57, 58 as illustrated in FIG. 13. Such removal operation from the back surface side of the large backlight chassis 53 is complicated and troublesome. The backlight chassis 53 may be inverted so that the back surface thereof faces upward to allow easy access to the back surface side of the backlight chassis 53 for the removal operation. In such a case, the work for inverting the backlight chassis 53 has to be additionally performed.

Generally, the back surface of the backlight chassis 53 is provided with the inverter circuit board for generating the high pulse voltage for driving the CCFLs 54, and the control circuit board for controlling the liquid crystal display panel 51. Those circuit boards have to be removed before detachment of the lamp holders 57, 58. It is likely that the engaging portion 64 of the lamp holder 57 or 58 is broken when it is removed from the engaging hole 65. In such a case, the lamp holders 57, 58 have to be replaced when replacing the reflection sheet 55, thus increasing the cost.

The lamp holder 30 illustrated in FIGS. 8 and 9 has the engaging portions 34, 34 that rotate in accordance with rotation of the lamp clips 31, 31 so as to be engaged with the engaging holes 14, 14 formed in the lamp housing surface 4a. The lamp holder 30 may be removed from the lamp housing surface 4a only by rotating the lamp clips 31, 31. The access to the back surface side of the backlight chassis 4 as described above is not required, and there is no risk of breaking and replacement of the lamp holder 30.

Generally, two types of lamp holders 57, 58 have been required for holding pairs of the CCFLs 5, 5 at the different lamp holding intervals P1 and P2 as illustrated in FIG. 13. In contrast, only one type of lamp holder is needed when the lamp holder 20 or 30 is used, thus reducing manufacturing cost.

The use of the lamp holders 20, 30 for setting two different lamp holding intervals P1 and P2 has been described. The lamp holding interval may be set to an arbitrary length so long as it is shorter than the lamp holding interval P1 that is the maximum length set for the lamp holder 20 or 30. Likewise the case where the interval between the adjacent CCFLs 5, 5 in the center portion is shorter and wider in the respective end portions on the lamp housing surface 4a, the type of the lamp holders required for setting the interval between the CCFLs 5,5 may be reduced. The interval between the CCFLs 5, 5 may also be finely set.

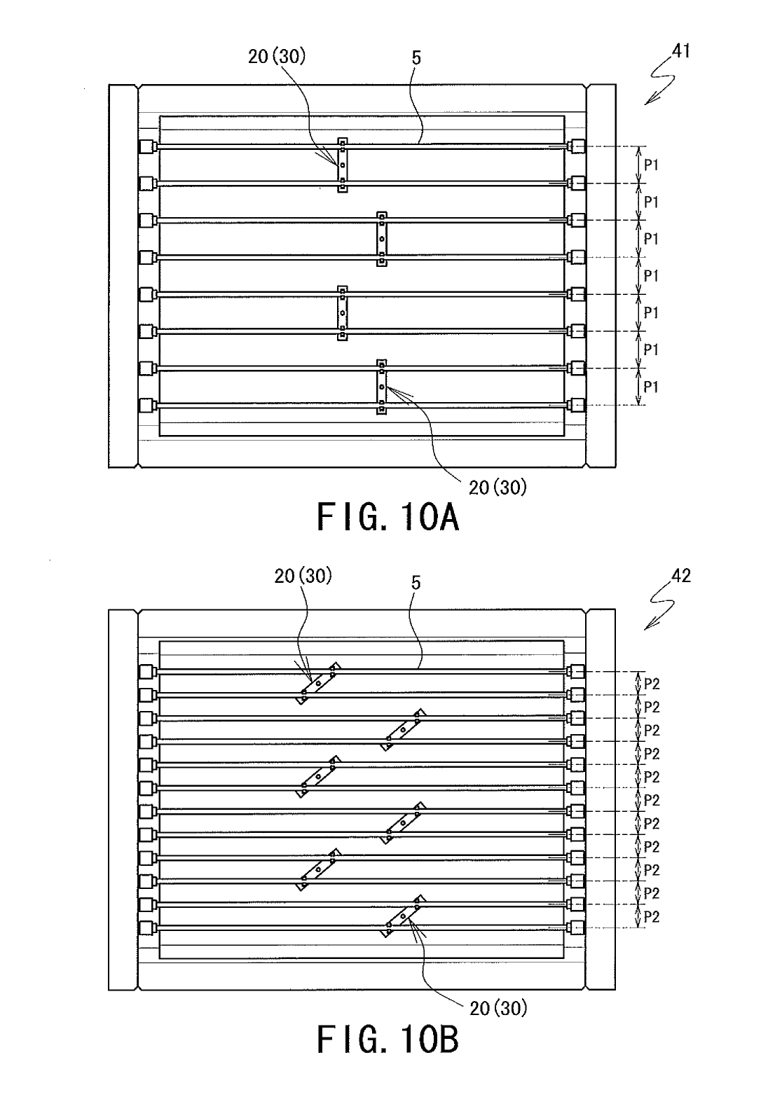

Referring to FIGS. 10A and 10B, the lamp holder 20 or 30 according to the preferred embodiments of the present invention may be employed also in the case where the interval between the adjacent CCFLs 5, 5 is uniformly set. The lamp holder 20 or 30 may be commonly employed for the backlight unit 41 having only the lamp holding interval P1 set as illustrated in FIG. 10A, and the backlight unit 42 having only the lamp holding interval P2 set as illustrated in FIG. 10B. The lamp holder may be commonly employed for the plural backlight units having different lamp holding intervals, thus reducing manufacturing cost.

The lamp holder, the backlight unit, and the display device according to the preferred embodiments of the present invention have been described. It is to be understood that the present invention is not limited to those preferred embodiments but may be changed into various forms without departing from the scope of the present invention. For example, the lamp holder according to the preferred embodiments of the present invention includes two lamp clips. However, three or more lamp clips may be used. The use of straight type CCFL as the light source lamp has been described. However, the present invention is applicable to a U-type CCFL, an external electrode fluorescent lamp that is called EEFL and includes electrodes disposed outside the glass tube at the end portion of the lamp.

1. A lamp holder having a plurality of lamp clips that hold a plurality of light source lamps at predetermined intervals and are rotatably supported on a base of the lamp holder.

2. The lamp holder according to claim 1, wherein the lamp clips are two in number.

3. The lamp holder according to claim 1,
wherein the lamp clips are integrated with engaging portions that are to be inserted into engaging holes formed in a flat lamp housing surface; and
the engaging portions are rotated in accordance with rotation of the lamp clips.

4. The lamp holder according to claim 3, wherein the engaging portions of the lamp clips are inserted into the engaging holes formed in the lamp housing surface, and rotated together with the lamp clips so as not to be removed from the engaging holes formed in the lamp housing surface.

5. A backlight unit that is disposed on a back surface of a display panel having an image display region, and irradiates light to the display panel,
wherein a plurality of light source lamps are provided in rows on a flat lamp housing surface;
each two or more of the plurality of light source lamps are held with a lamp holder;
a plurality of lamp clips that hold the two or more of the plurality of light source lamps at predetermined intervals are rotatably supported on a base of the lamp holder; and
the lamp holder is obliquely directed in accordance with the intervals between the light source lamps to be held.

6. The backlight unit according to claim 5, wherein the lamp clips are two in number.

7. The backlight unit according to claim 5,
wherein the lamp clips are integrated with engaging portions that are to be inserted into engaging holes formed in a flat lamp housing surface; and
the engaging portions are rotated in accordance with rotation of the lamp clips.

8. The backlight unit according to claim 7, wherein the engaging portions of the lamp clips are inserted into the engaging holes formed in the lamp housing surface, and rotated together with the lamp clips so as not to be removed from the engaging holes formed in the lamp housing surface.

9. A display device having a backlight unit that is disposed at a back surface side of a display panel having an image display region, and irradiates light to the display panel,
wherein the backlight unit is provided with a plurality of light source lamps in rows on a flat lamp housing surface;
each two or more of the plurality of light source lamps are held with a lamp holder;
a plurality of lamp clips that hold the two or more of the plurality of light source lamps at predetermined intervals are rotatably supported on a base of the lamp holder; and
the lamp holder is obliquely directed in accordance with the intervals between the light source lamps to be held.

10. The display device according to claim 9, wherein the lamp clips are two in number.

11. The display device according to claim 9,
wherein the lamp clips are integrated with engaging portions that are to be inserted into engaging holes formed in a flat lamp housing surface; and
the engaging portions are rotated in accordance with rotation of the lamp clips.

12. The display device according to claim 11, wherein the engaging portions of the lamp clips are inserted into the engaging holes formed in the lamp housing surface, and rotated together with the lamp clips so as not to be removed from the engaging holes formed in the lamp housing surface.
